(19) United States
(12) Patent Application Publication
(10) Pub. No.: US 2012/0249535 A1
(43) Pub. Date: Oct. 4, 2012

(54) SYSTEM FOR TRANSFORMATION AND ANIMATION OF IMAGES

(76) Inventor: George A. Castineiras, Farmington, CT (US)

(21) Appl. No.: 13/409,781

(22) Filed: Mar. 1, 2012

Related U.S. Application Data
(60) Provisional application No. 61/447,997, filed on Mar. 1, 2011.

(51) Int. Cl. G06T 15/00

(52) U.S. Cl. 345/419

(57) ABSTRACT

A computer based system for generating images includes a computing device having a processor operable with software and an input device in communications with the processor. The processor executing software to provide an image processing section, an image transformation section and an applications interface section. The image processing section is operable by the processor to control processing of two dimensional images. The image transformation section is operable by the processor to control transformation of the two dimensional images into transformed images having three dimensional appearances. The applications interface section is operable by the processor to enable use of said transformed images in a plurality of forms.

### CROSS REFERENCE TO RELATED APPLICATIONS

This application claims priority to U.S. Provisional Patent Application No. 61/447,997, entitled “System for Transformation and Animation of Images,” filed Mar. 1, 2011, the subject matter of which is herein incorporated by reference, in its entirety.

### FIELD OF THE INVENTION

The present invention relates generally to the modification of images, and in particular to a computer based system for converting two dimensional images into animated images and those exhibiting three dimensional attributes.

### BACKGROUND

Coloring books are generally available in retail stores for users to create artwork therein. Typically, a user or artist uses crayons, markers, pencils and/or paints to add color and/or shading to templates of two dimensional images, provided in the coloring books. In addition, software is generally available which enables users to create two-dimensional artwork using a computer.

The artwork can be reproduced or reprinted, in two-dimensional form, by various devices including copy machines and printers. The two-dimensional artwork can also be affixed to promotional items such as mugs, tee-shirts and hats via commercially available technologies.

### SUMMARY OF THE INVENTION

According to aspects illustrated herein, there is provided a computer based system for generating images including a computing device having a processor operable with software and an input device in communications with the processor. The processor executes the software to provide an image processing section, an image transformation section and an applications interface section. The image processing section is operable by the processor to control processing of two dimensional images. The image transformation section is operable by the processor to control transformation of the two dimensional images into transformed images having three dimensional appearances. The applications interface section is operable by the processor to enable use of the transformed images in a plurality of forms.

According to other aspects illustrated herein, the processor executes the software to provide a fundraising section that is operable by the processor with the image processing section, the image transformation section and/or the applications interface section. In one embodiment, the fundraising section is operable by the processor to allocate at least a portion of proceeds from transactions relating to the transformed images to a third party. The third party is, for example, a charitable organization and/or a profit seeking organization. In addition, the fundraising section includes, for example, a plurality of affiliation subsections operable by the processor to generate a shopping list of applications for using the transformed images for one or more purposes. The plurality of affiliation subsections includes a promotional materials subsection, an e-mail subsection, a video gaming subsection, a screen saver subsection, a mobile phone subsection, a toy distribution subsection and/or a charitable organization subsection.

According to other aspects illustrated herein, the image transformation section includes a first transformation subsection operable by the processor to control transformation of the transformed images into three dimensional physical bodies. In one embodiment, the image transformation section also includes a second transformation subsection operable by the processor to control the transformation of the two dimensional images into the transformed images having three dimensional appearances. In yet another embodiment, the image transformation section, includes a third transformation subsection operable by the processor to control a lenticular printing device and/or a fourth transformation subsection operable by the processor to control a process for animation of the transformed images.

### BRIEF DESCRIPTION OF THE DRAWINGS

FIG. 1 is a schematic diagram of a computer based system for animation and transformation of images, according to the present invention;

FIG. 2 is a schematic diagram of the computer based system of FIG. 1 including a fundraising section;

FIG. 3 is a schematic diagram of a portion of the computer based system of FIG. 1, showing details of the image processing section;

FIG. 4 is a schematic diagram of a portion of the computer based system of FIG. 1, showing details of the image transformation section; and

FIG. 5 is a schematic diagram of a portion of the computer based system of FIG. 1, showing details of the application interface section.

### DETAILED DESCRIPTION OF THE INVENTION

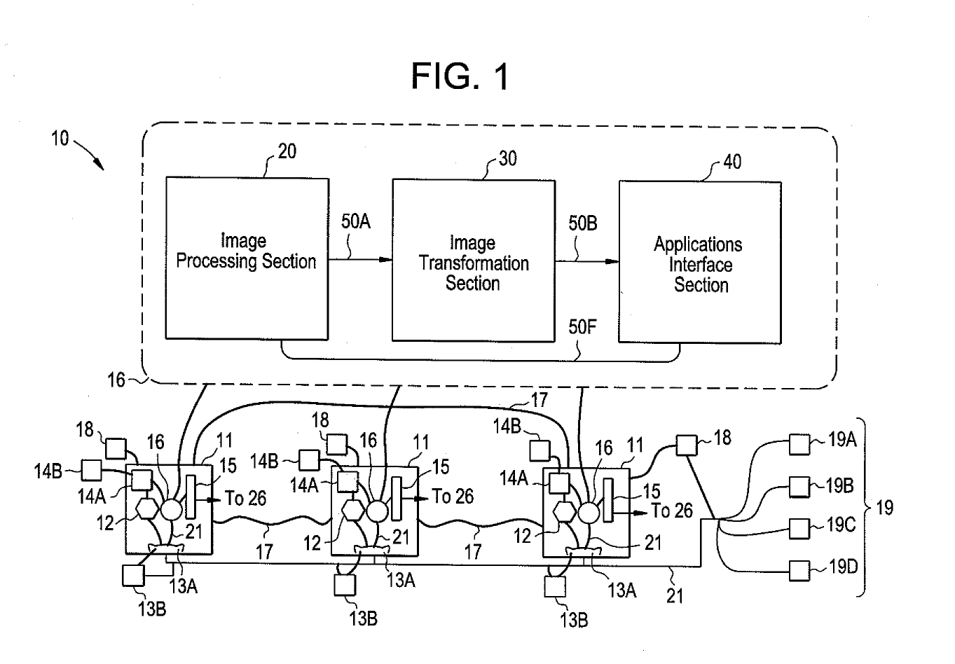

Referring to FIG. 1 a computer based system for animation and transformation of images is generally designated by the numeral 10. The computer based system 10, includes one or more computers 11, for example three computers are illustrated in FIG. 1 which allows for multiple users to access the computer based system 10. The computer based system 10, includes a computer processor 12, one or more data input devices 13A, a display interface 14A, a data storage device 15 and software 16 installed in each of the computers 11. For example, the software 16 is executable by the computer processor 12 of any computer 11 to provide the conversion, transformation and/or animation as described herein. The data input devices 13A include, but are not limited to, USB ports, wireless receivers, telephone jacks, cameras, video cameras, and Ethernet connections for inputting data and information into the computer 11. In addition, the computer based system 10, includes one or more additional input devices 13B that are in communication with the respective computer 11. The input devices 13B include, but are not limited to, one or more keyboards, touch screens, wireless receivers, scanners, cameras, video cameras, bar code readers, mobile telephones and infra-red scanners. The computer based system 10, also includes a display 14B that is in communication with the respective display interface 14A. The computers 11 are interconnected to one another. The processor 12 executes the software 16 which is operable by the processor 12 to manage communications between each of the computers 11 via a communications network 17, for example an intranet or the internet. The software 16 can be accessed by users via an interactive website. The computers 11 are also in communication with an encoding device 18, such as a bar code generator, a label applicator, and/or an alpha-numeric character generator.

While three computers 11 are illustrated, the present invention is not limited in this regard, as any number of computers may be employed including, one, two or more than three computers. Although the software 16 is described as being installed in each of the computers 11, the present invention is not limited in this regard as the software 16 or portions thereof may be installed in any one or more of the computers and/or remote from the computers, for example in a remote server. In one embodiment the software 16 is provided as a service via a cloud computing environment. In addition, while the computers 11 are described as being interconnected to one another, the present invention is not limited in this regard as one or more of the computers may operate independently of any of the other computers.

Details of components (e.g., sub-routines and algorithms) of the software 16 is illustrated in an enlarged view presented within the dashed lines shown on FIG. 1. For example, the software 16 is executable by the processor 12 to provide an image processing section 20 for processing images, via the processor 12, such as two dimensional images inputted into the computer 11 (e.g., inputted two dimensional images input into the computer 11 via the input devices 13A and/or 13B) and/or three dimensional images inputted into the computer 11. The software 16 is executable by the processor 12 to provide an image transformation section 30 which causes, via the processor 12, transformation of inputted images, such as the two dimensional images, into transformed images having three dimensional appearances by execution of a suitable algorithm. The software 16 is executable by the processor 12 to provide an applications interface section 40 which is operable by the processor 12 to enable use of the transformed images in a plurality of forms, as described below. The image processing section 20, the image transformation section 30 and the applications interface section 40 are operable, by the processor 12, with one another and each include algorithms and/or subroutines operable to affect their respective functions, as described below.

In one embodiment, the image processing section 20, the image transformation section 30 and the applications interface section 40 reside in different computers and communicate with one another as follows. The image processing section 20 communicates with the image transformation section 30 via a communication link 50A, for example, an internet connection. The image transformation section 30 communicates with the applications interface section 40 via another communications link 50B, for example, an internet connection. The image processing section 20 communicates with the applications interface section 40 via another communications link 50F, for example, an internet connection. While the communications links 50A, 50B and 50F are described as being internet connections, the present invention is not limited in this regard as other types of communications links may be employed including, but not limited to, bidirectional links, a point-to-point links, fiber optic links, proximity connections and radio waves including Bluetooth® technologies residing in mobile telephones and computers, e-mail, mail, courier and hand delivery. In one embodiment, one or more of the computers 11 and/or all or portions of the software 16 reside in one or more mobile telephones or handheld computing devices.

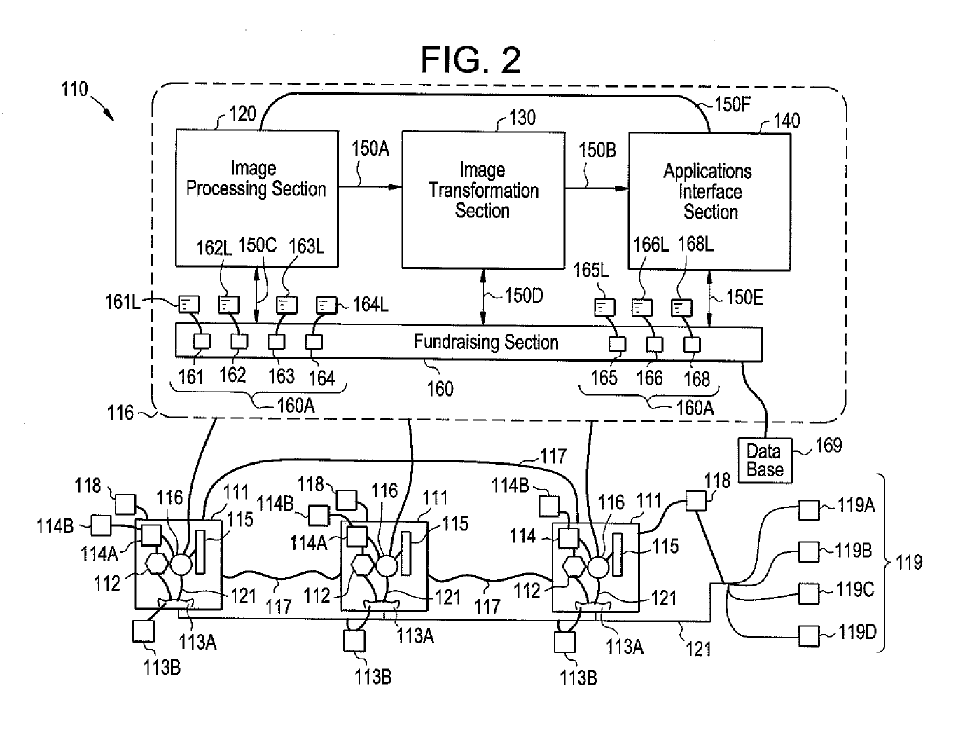

FIG. 2 illustrates a computer based system for animation and transformation of images generally designated by the numeral 110, which is similar to the computer based system 10 of FIG. 1. Therefore, like elements are assigned like reference numbers, preceded by the numeral 1. The computer based system 110, includes one or more computers 111, for example three computers are illustrated in FIG. 2. Each of the computers 111 has a computer processor 112, one or more input devices 113A, a display interface 114A, a data storage device 115 and software 116 installed in each of the computers. For example, the software 116 is executable by the computer processor 12 of any computer 11 to provide the conversion, transformation and/or animation as described herein. The computer based system 110 also includes one or more additional input devices 113B that are in communication with the respective computer 111. The computer based system 110, also includes a display 114B that is in communication with the respective display interface 114A. The computers 111 are also in communication with an encoding device 118, such as a bar code generator, a label applicator, and/or an alpha-numeric character generator. The processor 12 executes the software 116 which is operable by the processor 12 to manage communications between each of the computers 111 via a communications network 117, for example an intranet or the internet.

Details of components (e.g., sub-routines and algorithms) of the software 116 is illustrated in an enlarged view presented within the dashed lines shown on FIG. 2. In one embodiment, the software 116 is executable by the processor 12 to provide an image processing section 120 for processing images, by the processor 12, such as two dimensional images input into the computer (e.g., inputted two dimensional images input into the computer via the input devices 13A and/or 13B) and/or three dimensional images input into the computer 11. The software 116 is executable by the processor 12 to provide an image transformation section 130, which causes transformation of images, by the processor 12, such as the two dimensional images into transformed images having three dimensional appearances by execution of a suitable algorithm. The software 116 is executable by the processor 12 to provide an applications interface section 140, which is operable by the processor 12 to enable use of the transformed images in a plurality of forms, as described below. In addition, the software 116 is executable by the processor to provide a fundraising section 160. The image processing section 120, the image transformation section 130, the applications interface section 140 and the fundraising section 160 are operable, by the processor 12, with one another and each include algorithms and/or subroutines operable to affect their respective functions, as described below.

In one embodiment, the image processing section 120, the image transformation section 130, the applications interface section 140 and the fundraising section 160 reside in different computers and communicate with one another as follows. The image processing section 120 communicates with the image transformation section 130 via a communication link 150A, for example an internet connection. The image transformation section 130 communicates with the applications interface section 140 via another communications link 150B, for example an internet connection. The image processing section 120 communicates with the applications interface section 140 via another communications link 150F, for example, an internet connection. The fundraising section 160 is in communication with the image processing section 120, the image transformation section 130 and the applications interface section 140, via communication links 150C, 150D, and 150E (e.g., internet connections), respectively.

While the communications links 150A through 150F are described as being internet connections the present invention is not limited in this regard as other types of communications links may be employed including, but not limited to, bidirectional links, a point-to-point links, fiber optic links, proximity connections and radio waves including Bluetooth® technologies residing in mobile telephones and computers, e-mail, mail, courier and hand delivery. In one embodiment, one or more of the computers 111 and/or all or portions of the software 116 reside in one or more mobile telephones or handheld computing devices.

The fundraising section 160 is operable, by the processor 12, to enable a user to designate and send, to a third party, all or a portion of proceeds received for services and/or products. In one embodiment, the third party is a charitable organization. In one embodiment, the third party is a profit seeking entity, a corporation, a partnership, a retail organization and/or a wholesale organization. In one embodiment, the fundraising section 160 adjusts pricing for products or services ordered through the computer based system 110. For example, the fundraising section 160 applies a discount for services and/or products ordered through the computer based system 110 depending on a status of a relationship between the third party and another entity. The status of the relationship between the third party and the user or another entity includes, but is not limited to, the user or other entity being a member, advocate, supporter or contributor of the third party's association, a profit seeking entity, a corporation, a partnership, a charitable organization, a high volume purchaser and/or a community organization.

In one embodiment, the fundraising section 160 includes a plurality of affiliation subsections shown generally at 160A, each of which are operable, by the processor 12, to generate shopping lists of applications for using the transformed images (e.g., three dimensional images) for one or more purposes associated with a particular affiliation, application, or user interest, as described below. The shopping lists include, for example a list, menu or interactive webpage that identifies, describes and illustrates products or services for purchase by the user and are operable to allow the user to select and order products and services from the shopping lists. The plurality of affiliation subsections 160A include, but are not limited to, a promotional materials subsection 161, an e-mail subsection 162, a video gaming subsection 163, a screen saver subsection 164, a mobile phone subsection 165, a toy distribution subsection 166 and a charitable organization subsection 168.

The promotional materials subsection 161 is operable, by the processor 12, to generate a shopping list 161L of products and services that can be used in conjunction with the transformed image for advertising or promoting a particular entity or purpose such as, but not limited to, mugs for advertising a business, tee shirts for advertising a sports team and figurines for communicating a political position. The e-mail subsection 162 is operable, by the processor 12, to generate a shopping list 162L of products and services that can be used in conjunction with the transformed image in e-mail transmissions such as text, attachments, banners, footers, signatures or can be distributed via e-mail. The video gaming subsection 163 is operable, by the processor 12, to generate a shopping list 163L of games, products and services that can be used in conjunction with the transformed image by users that have an interest in video games, including but not limited to a list of video games, game systems, controls and accessories. The screen saver subsection 164 is operable, by the processor 12, to generate a shopping list 164L of products and services that can be used in conjunction with the transformed image as screen savers on computer display screens. The mobile phone subsection 165 is operable, by the processor 12, to generate a shopping list 165L of products and services that can be used in conjunction with the transformed image, including Apps, mobile phone services, and mobile phones and accessories. The toy distribution subsection 166 is operable, by the processor 12, to generate a shopping list 166L of products and services that can be used in conjunction with the transformed image for distributing toys for charity and/or for profit. The charitable organization subsection 168 is operable, by the processor 12, to generate a shopping list 168L of products and services that can be used in conjunction with the transformed image for charitable organization purposes, such as but not limited to donation campaigns and distribution of religious items.

Each of the above listed affiliation subsections 160A including, 161, 162, 163,164, 165, 166 and 168, includes algorithms and/or subroutines which are operable, by the processor 12, to identify, select, classify and recommend products and/or applications that use the transformed images based on predetermined criteria. The affiliation subsections 160A are in communication with a database 169 that stores information indicative of a plurality of different products including, but not limited to postage stamps, mugs, tee-shirts, hats, aprons, mugs, stationary, posters, Rubik's cubes, website design, signs and advertisements. Thus the affiliation subsections 160A are operable, by the processor 12, to query the database 169 for the product information stored therein, and identify, select, classify and recommend products and/or applications for using the transformed images, according to predetermined criteria. The predetermined criteria includes but is not limited to, historical usage information, user profile data (e.g., age, membership in charitable, retail, business, religious and commerce organizations), cost, spending limitations defined by the user and geographical location of the user. The affiliation subsections 160A are operable, by the processor 12, to display such products and/or applications in the shopping list on a computer screen presented via the display devices 14A and 114A and/or on an interactive webpage.

Referring back to FIG. 1, a plurality of templates 19 are provided for creating two-dimensional images thereon. The templates 19 include, for example, coloring books, sketches, artforms, blank sheets, graphs, icons, photographs and art work, thereon. In one embodiment, the templates 19 include an activity book which includes stories, instructions, introduction of characters, art forms for coloring and/or decoration by the user, URL links, and access information to a website. The content of the activity book is reproduced by the software 16 and stored in the data storage device 15. The activity book includes appropriate links and references to the interactive website. The activity book and website identify options for the user to upload art work, such as that created in the activity book, to the website. The options include use of one or more of the input devices 13A and 13B to receive, transform and input the artwork into digital media within the computer 11. In one embodiment, the templates 19 include markers to identify portions of the template to be cropped after transforming the artwork into digital media by one or more of the input devices 13A and 13B. The image processing section 20 includes an algorithm that recognizes the markers and automatically crops the artwork as it is transformed into the digital media.

The plurality of templates 19, include, but are not limited to, electronic templates 19A, hard copy templates 19B, pre-coded hard copy templates 19C and/or a pre-coded electronic templates 19D. Hard copy templates include, but are not limited to, templates printed on paper, cardboard, foam, plastic or the like. The electronic templates 19A, the hard copy templates 19B, the pre-coded hard copy templates 19C and the pre-coded electronic templates 19D are made available to the user for example, through retail stores, online via the internet and/or charitable organizations. The electronic templates 19A and the pre-coded electronic templates 19D are similar to the hard copy templates 19B and the pre-coded hard copy templates 19C, respectively, except that, rather than hard copy form, the electronic templates 19A and the pre-coded electronic templates 19D are in a suitable digital format or file, such as a JPEG, PDF, TIFF, BMP, Microsoft Power Point, Word or Excel, or other suitable format. The pre-coded hard copy templates 19C and the pre-coded electronic templates 19D are similar to the hard copy templates 19B and the electronic templates 19A, respectively, except that pre-coded hard copy templates 19C and the pre-coded electronic templates 19D, have processing codes, such as bar codes, page numbers, markers or the like applied thereon and on one or more pages when initially purchased by a user. The processing codes include, but are not limited to, information indicative of the image and/or an association between the image and the affiliation subsections 160A or interests of the user. In one embodiment, such information includes addresses, e-mail addresses, copyright data, trademark data, telephone numbers, and website URLs. The templates 19 are processed by the computer based system 10 through operation of the software 16, the interactive website, interface with the computers 11, including the data input devices 13A and 13B and the encoding devices 18, as described herein. In one embodiment, the software 16 includes an algorithm that queries the user regarding the source from which the user acquired the templates 19 and stores such information in the data storage device 15.

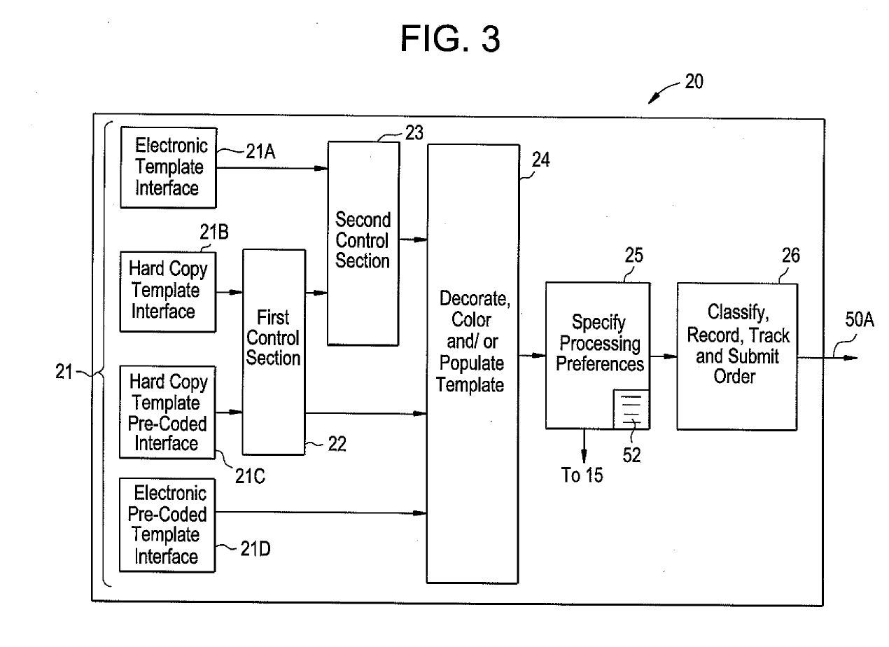

Referring to FIG. 3, the image processing section 20 includes a plurality of template processing interfaces 21 that are in communication with the data input devices 13A and 13B. Each of the template processing interfaces 21 includes software and hardware interfaces required for communication between the software 16 and the data input devices 13A and 13B. For example, the plurality of template processing interfaces 21 includes, but is not limited to, an interface 21A for processing the electronic templates 19A, an interface 21B for processing the hard copy templates 19B, an interface 21C for processing the pre-coded hard copy templates 19C and/or an interface 21D for processing the pre-coded electronic templates 19D. The interface 21A for the processing electronic templates 19A establishes communication with the data input device 13A, such as but not limited to, the USB port. The interface 21B for processing the hard copy templates 19B establishes communication with the data input devices 13A and/or 13B, such as but not limited to, the camera and the video camera. The interface 21C for processing the pre-coded hard copy templates 19C establishes communication with the data input device 13B, such as but not limited to, the scanner and the bar code reader. The interface 21D for processing the pre-coded electronic templates 19D establishes communication with the data input device 13A, such as but not limited to, the USB port. The image processing section 120 of FIG. 2 is configured similar to the imaging processing section 20.

As shown in FIG. 3, the interface 21B for processing the hard copy templates 19B and the interface 21C for processing the pre-coded hard copy templates 19C communicate with a first control section 22 that is operable, by the processor 12, to select the type of the data input device 13A or 13B (e.g., camera, scanner, video camera, mobile phone, etc.) for conversion of the hard copy templates 19B and the pre-coded hard copy templates 19C to a digital format. The first control section 22 is operable, by the processor 12, to control the data input devices 13A and/or 13B to affect the conversion of the hard copy templates 19B and the pre-coded hard copy templates 19C to a digital format. In addition, the interface 21A for processing the electronic template 19A communicates with a second control section 23 which communicates with and controls the encoder 18, for generating the codes, designating the type of encoder and applying codes, such as bar codes or the like to the templates 19, as required. In one embodiment, the data input device 13A is a keyboard and the encoder 18 is a printer which applies the codes to the templates 19B and 19C. The first control section 22 checks for the presence, compatibility and legibility of codes on the templates 19.

Still referring to FIG. 3, the imaging processing section 20 of the software 16 includes a modification section 24 for electronically coloring, decorating, painting, populating with data such as text and otherwise modifying the electronic templates 19A, the hard copy templates 19B, the pre-coded hard copy templates 19C and the pre-coded electronic templates 19D, thereby creating a modified image such as a piece of art work. The modification section 24 automatically and/or manually (e.g., via a keyboard input) assigns a unique identification code to each modified image for further reference and tracking. The modification section 24 is in communication with the second control section 23, for modifying the electronic template 19A and the hard copy template 19B. The modification section 24 is in communication with the first control section 22, for modifying the pre-coded hard copy template 19C. In addition, the modification section 24 is in communication with the interface 21D for modifying the electronic pre-coded template 19D. The modification section 24 software routines include functions, such as, for example, electronic paint brushes, color palettes and electronic crayons and other electronic coloring and patterning tools, which, for example, are operable for enabling the user to color and/or decorate the templates 19A-19D via a suitable input such as a keyboard, mouse or a mobile phone.

As shown in FIG. 3, the modification section 24 is in communication with a specification section 25 which is operable, by the processor 12 to allow a user to input an order 52 via the data input device 13A and/or 13B for further processing of the modified image. The order 52, includes, for example, specifications for creating transformed images such as but not limited to specifications for transformation of the modified image into a three dimensional body, transformation of the modified image into an electronic image having a three dimensional appearance, printing the modified image on a three dimensional object (e.g., a mug, a Rubik's cube and/or a tag) and/or animating the modified image, as described herein. In one embodiment, the order 52 includes specifications for animating the electronic image having a three dimensional appearance and/or the transformed image. The order 52 also includes the quantity desired and shipping address, such as a postal address or e-mail address. The order 52 can include a single special order item or multiple high volume quantities. The specification section 25 is in communication with a database 26 for receiving data contained in the order 52 and classifying, recording, tracking and submitting the data contained in the order 52 to the image transformation section 30 via the communications link 50A. The database 26 is also in communication with and shares information with the data storage device 15. The image transformation section 130 of FIG. 2 is configured similar to the image transformation section 30.

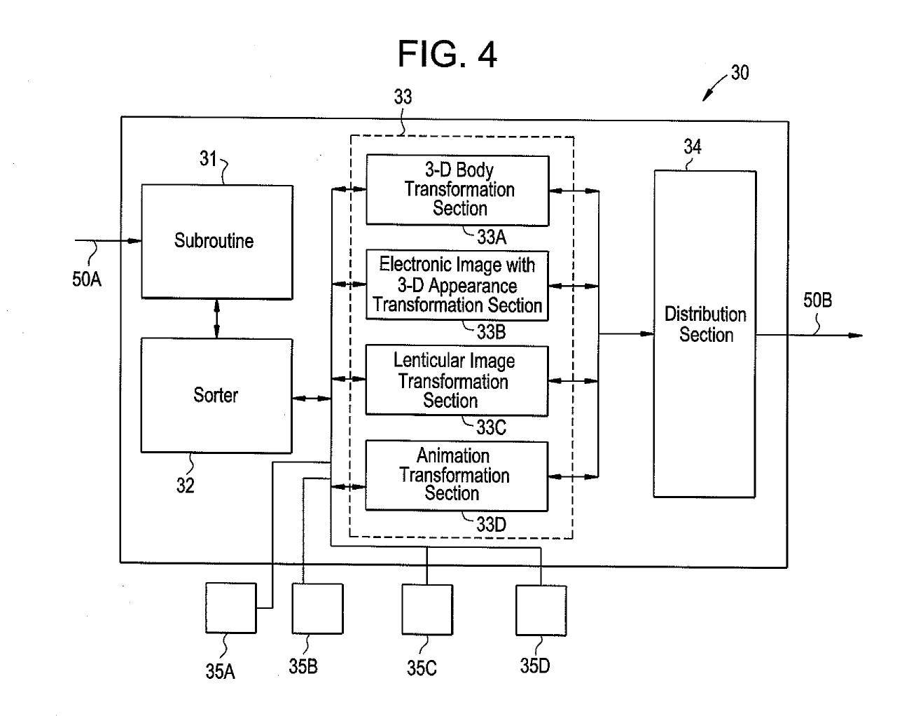

Referring to FIG. 4, the image transformation section 30 includes a subroutine 31 for receiving data, such as data relating to the order 52 via the communications link 50A. The subroutine 31 is in communication with a sorter section 32 for sorting the data relating to the order 52. The sorter section 32 is operable, by the processor 12, to sort the data relating to the order 52, for example, according to the user identification, information relating to the affiliation subsection 160A, the charitable organization, the profit seeking entity, type of template 19 and/or pricing. The sorter section 32 is in communication with a transformation subsection 33. The transformation subsection 33 includes, for example, a first transformation subsection 33A for transforming the modified image into a three dimensional physical body or object. In one embodiment, the first transformation subsection 33A includes subroutines and/or algorithms operable, by the processor 12, to control a printer 35A which creates a three dimensional object based on and representative of the modified image.

In one embodiment, transformation of the modified image into a three dimensional physical body or object includes: uploading the modified image into the data storage device 15 using one or more of the input devices 13A and 13B; and detecting (e.g., using the software 16) if the modified image is from one of the templates 19 (e.g., pre-coded hard copy templates 19C and/or the pre-coded electronic templates 19D). In one embodiment the software 16 detects the processing codes such as, but not limited to the page numbers on the templates 19. If the processing code is detected, the software 16 isolates predetermined fields from uploaded modified image. The software 16 is executable by the processor 12 to generate texture files from the uploaded modified images. The software 16 is executable by the processor 12 to apply the texture files to a three dimensional model for use in printing on a printer capable of printing three dimensional objects.

In one embodiment, transformation of the modified image into a three dimensional physical body or object includes: uploading the modified image into the data storage device 15 using one or more of the input devices 13A and 13B; and detecting and determining a page number of the template 19. For each page a portion of the top and bottom, for example but not limited to 5% of the height of the page, and 10% of the width of the page from the middle is isolated from the remainder of the page. On each horizontal line of each page a predetermined number of pixels (e.g., 200 pixels) are gathered and evenly spaced apart from one another. On each vertical line of each page a predetermined number of pixels (e.g., 200 pixels) are gathered and evenly spaced apart from one another. Each pixel is assigned a value based on its position. For example, the first pixel is assigned a value of 1; the seventh pixel is assigned a value of 49 (i.e., 7×7), and the 59^{th} pixel is assigned a value of 3481 (i.e., 59×59). The modified image is read by the software 16 one pixel at a time. If a pixel is a dark pixel (closer to black than white) the value of the pixel is added to the total value for that line. The total values of each line are compared to a predetermined total values for a line. The spacing between pixels in the modified image is determined by suitable means (e.g., by use of the Pythagorean theorem), the total number of black pixels is determined and the area of the modified image to isolate relative to a predetermined ideal area is identified. The distance between pixels of the modified image is compared to predetermined distances to determine which is of lesser magnitude. A predetermined pattern is adjusted to match the size and dimensions of the modified image that has been uploaded into the data storage device 15. An automatic cut out of pattern is performed, for example by image masking leaving only the decorated portion of the modified image, without the pattern. The cut out is presented to the user for approval. The user is provided the option to correct the cut out, for example by cropping and/or rotating the image. The cut out is resized and formatted into a suitable texture file, for example using a computer aided design file format such as a “.3ds/.vrml (3D) model file” for printers capable of generating three dimensional objects. The texture file is saved in the data storage device 15, for example in a folder or zip folder and is used for generating the three dimensional physical body or object.

In addition, the transformation subsection 33 includes, for example, a second transformation subsection 33B which includes subroutines and/or algorithms operable, by the processor 12, to control a device 35B for creating a digital rendering of the modified image with three dimensional appearances.

In addition, the transformation subsection 33 includes, for example, a third transformation subsection 33C which includes subroutines and/or algorithms operable, by the processor 12, to control a lenticular printing device 35C. In one embodiment the lenticular printing device 35C splits multiple images into hundreds of narrow strips and then alternates them side by side in regular order, called interlacing. The interlaced strips are then displayed behind an optically clear plastic with a series of parallel grooves formed therein and creating a plurality of lenses, with one lens per set of strips. At one viewing distance the lenses are barely apparent. Since each of a viewer's eyes is spaced apart, each eye receives an image from the lenses from a slightly different angle. Refraction of the lenses ensures that each eye then sees a different set of image stripes. This gives the viewer a depth effect. The lenticular printing device can also create other effects, including but not limited to morph, flip, animation and the like.

The transformation subsection 33 includes, for example a fourth transformation subsection 33D which includes subroutines and/or algorithms operable, by the processor 12, to control a device 35D for animating the modified image and/or the transformed image. In one embodiment, the device 35D includes a server and a computer program residing on the internet. In one embodiment, the animation of the modified images includes: 1) uploading the modified image into the data storage device 15 using one or more of the input devices 13A and 13B; 2) resizing and cropping the modified image into progressively smaller sizes; 3) overlaying the resized modified images, one at a time onto a background image on a printable medium; 4) arranging the printable mediums adjacent to one another to form a single sprite; and 5) use of the software 16 to loop through the sprite to display the animation.

In one embodiment, one or more of the first through fourth transformation subsections 33A-33D, including one or more of the lenticular printing device 35B, the device 35C for creating a digital rendering of the modified image with three dimensional appearances, the device 35D for animating the modified and/or the transformed image and/or the printer 35A which creates a three dimensional object, communicate with one another via suitable communications links and/or are located in a commonly owned group of facilities and/or a single facility.

In one embodiment, the transformation subsection 33 is located remotely from the subroutine 31, for example the transformation subsection can be located at facilities of a third party vendor. In one embodiment, the lenticular printing device 35B, the device 35C for creating a digital rendering of the modified image with three dimensional appearances, the device 35D for animating the modified and/or transformed image and/or the printer 35A which creates a three dimensional object is/are located remotely from the subroutine 31, for example at a facility of a third party vendor using the third party vendor's software and/or equipment.

In one embodiment, the lenticular printer 35B prints directly onto the back of the lenticular lens material instead of having to laminate printed paper sheets in close register. Lenticular images can appear to be three dimensional, or they can suddenly ‘flip’ between different images, or gradually ‘morph’ or ‘zoom’ between them, or they can appear to move with multi-frame animations that can be looped for continuous motion. Several effects can be combined at once.

The transformation subsection 33 is in communication with a distribution section 34 which includes subroutines and/or algorithms operable, by the processor 12, to control the transfer of products resulting from the first through fourth transformation sections 33A-33D to the distribution section. The distribution section 34 transfers electronic versions of and/or information relating to (e.g., tracking information) the products resulting from the first through fourth transformation sections 33A-33D to the applications interface section 40 via the communications link 50B.

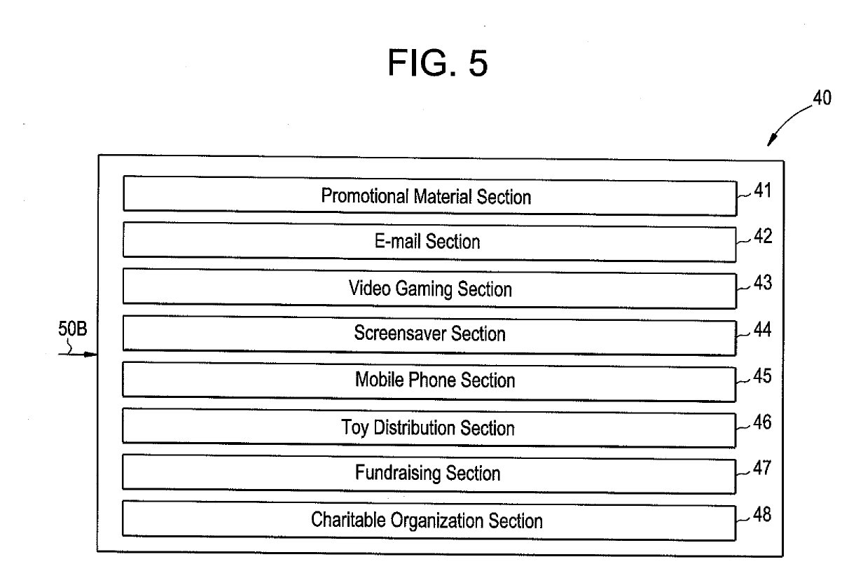

Referring to FIG. 5, the applications interface section 40 includes a promotional materials subsection 41, an e-mail subsection 42, a video gaming subsection 43, a screen saver subsection 44, a mobile phone subsection 45, a toy distribution subsection 46, a fundraising subsection 47 and a charitable organization subsection 48. Each of the above listed subsections includes subroutines and/or algorithms operable, by the processor 12, to distribute, activate, authorize and/or track use of products transferred from distribution section 34 of the image transformation section 30 for application to a plurality of different products including, but not limited to postage stamps, mugs, tee-shirts, hats, aprons, mugs, stationary, posters, Rubik's cubes, website design, signs and advertisements. In one embodiment, the products are listed on a webpage of the interactive website. The applications interface section 140 of FIG. 2 is configured similar to the applications interface section 40.

During operation of the computer based system for animation and transformation of images 10, one or more of the templates 19A-19D and inputted images, such as two dimensional images are processed in the image processing section 20. The imaging processing section 20 controls the input devices 13A and/or 13B, which scans, converts to digital form, assigns and/or applies codes to the templates 19A-19D, as required. In the imaging processing section 20 or while linked thereto via the interactive website, mobile phone, or the computer 12, the user can input and decorate the templates 19A-19D by coloring or shading or the like via input from a suitable keyboard, touch screen and/or mobile telephone. The orders 52 for transforming the decorated two dimensional images are specified in the specification section 25. The orders 52 include, for example, specifications for transforming the two dimensional images into a three dimensional object, transformation into an electronic image having a three dimensional appearance, printing the two dimensional image on a three dimensional object and/or animating the modified and/or transformed image. The database 26 receives data contained in the order 52 and classifies, records, tracks and submits the data contained in the order 52 to the image transformation section 30 via the communications link 50A.

In the transformation section 30, the two dimensional inputted images are transformed into a modified image, such as a three dimensional object, an electronic image having a three dimensional appearance and/or an animation of the modified and/or transformed image. The transformed images and the animated modified and/or transformed images are transferred to the applications interface section 40 for one or more uses, including, promotional materials, e-mail attachments, video gaming, screen savers, mobile phones, toy distribution, fundraising and charitable organizations. In one embodiment, the transformation of the inputted images into the modified images, imparts lifelike characteristics (e.g., characteristics representing real life including but not limited to movement, appearance and expression) to the modified images.

In one embodiment, the image processing section 120, the image transformation section 130 and/or the applications interface section 140 interface with a fundraising section 160, to allocate some or all of the proceeds relating to processing, use and sale of the inputted images, transforming the inputted images into the modified images, the animated modified and/or transformed images and/or using the modified or transformed images, to a third party, such as a charitable organization, a profit seeking organization, a corporation, a retail entity, a wholesale entity and/or a partnership. In one embodiment, proceeds from the sale of promotional materials and/or royalties obtained from licensed use of the modified and/or transformed images are allocated to the third party.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

1. A computer based system for generating images comprising:
a computing device having a processor operable with software and an input device in communications with said processor;
said processor executing said software to provide an image processing section, an image transformation section and an applications interface section;
said image processing section being operable by said processor to control processing of inputted two dimensional images;
said image transformation section being operable by said processor to control transformation of said inputted two dimensional images into transformed images having three dimensional appearances; and
said applications interface section being operable by said processor to enable use of said transformed images in a plurality of forms.

2. The computer based system of claims 1, said processor executing said software to provide a fundraising section operable by said processor with at least one of said image processing section, said image transformation section and said applications interface section.

3. The computer based system of claim 2, wherein said fundraising section is operable by said processor to allocate at least a portion of proceeds from transactions relating to said transformed images to a third party.

4. The computer based system of claim 3, wherein the third party is at least one of a charitable organization and a profit seeking organization.

5. The computer based system of claim 2, wherein said fundraising section includes a plurality of affiliation subsections operable by said processor to generate a shopping list of applications for using said transformed images for one or more purposes.

6. The computer based system of claim 5, wherein said plurality of affiliation subsections includes at least one of a promotional materials subsection, an e-mail subsection, a video gaming subsection, a screen saver subsection, a mobile phone subsection, a toy distribution subsection and a charitable organization subsection.

7. The computer based system of claim 1, wherein said image transformation section comprises at least one of:
a first transformation subsection operable by said processor to control transformation of said transformed images into three dimensional physical bodies;
a second transformation subsection operable by said processor to control said transformation of said two dimensional images into said transformed images having said three dimensional appearances;
a third transformation subsection operable by said processor to control a lenticular printing device; and
a fourth transformation subsection operable by said processor to control a process for animation of said transformed images.

8. The computer based system of claim 7, wherein said first transformation subsection is operable by said processor to control a printer operable to create said three dimensional physical bodies.

9. The computer based system of claim 1, wherein said image processing section is operable by said processor to control transformation of hard copy two-dimensional images into an electronic format.

10. The computer based system of claim 1, wherein said image processing section is operable by said processor to control encoding of said two dimensional images.

11. The computer based system of claim 1, wherein said image processing section includes a modification section operable by said processor to enable a user to modify said two dimensional images into a modified image.

12. The computer based system of claim 11, wherein said modifying of said two dimensional images includes at least one of electronically coloring, decorating, painting and adding text to said two dimensional image.

13. The computer based system of claim 11, wherein said image processing section includes a specification section operable by said processor to enable a user to create an order for processing said modified images.

14. The computer based system of claim 11, wherein said order includes at least one of specifications for transformation of said modified image into a three dimensional body, transformation of said modified image into an electronic image having a three dimensional appearance and animating at least one of said modified image and said transformed image.
